(19) United States
(12) Patent Application Publication
(10) Pub. No.: US 2012/0291628 A1
(43) Pub. Date: Nov. 22, 2012

(54) EXHAUST GAS POST-TREATMENT SYSTEM

(75) Inventors: Jung Min SEO, Suwon-si (KR); Sungmu CHOI, Seongnam-si (KR)

(73) Assignee: Hyundai Motor Company, Seoul (KR)

(21) Appl. No.: 13/466,676

(22) Filed: May 8, 2012

(30) Foreign Application Priority Data
May 17, 2011 (KR) 10-2011-0046283

(51) Int. Cl. B01D 46/46

(52) U.S. Cl. 95/18

(57) ABSTRACT

An exhaust gas post-treatment method may include a white smoke elimination step that maintains a temperature of exhaust gas at a first predetermined temperature for a first predetermined time so as to eliminate moisture from a sulfur component, and a diesel particulate filter regeneration step that maintains a temperature of exhaust gas at a second predetermined temperature higher than the first predetermined temperature for a second predetermined time after the white smoke elimination step ends so as to burn particulate matter trapped in a diesel particulate filter.

### CROSS-REFERENCE TO RELATED APPLICATION

The present application claims priority to Korean Patent Application No. 10-2011-0046283 filed in the Korean Intellectual Property Office on May 17, 2011, the entire contents of which is incorporated herein for all purposes by this reference.

### BACKGROUND OF THE INVENTION

1. Field of the Invention

The present invention relates to an exhaust gas post-treatment method that traps particulate matter included in exhaust gas and raises temperature of exhaust gas to regenerate a DPF (diesel particulate filter).

2. Description of Related Art

Reducing harmful matter is an important problem in a diesel automobile that generates a large amount of harmful exhaust gas. Particularly, it is necessary to reduce PM (particulate matter) caused by incomplete combustion of a fuel.

A variety of techniques have been introduced to reduce the PM, and among them there is a DPF (diesel particulate filter) for trapping the PM of the exhaust gas and increasing the temperature of the trapped PM to a higher temperature than the ignition point thereof to be eliminated.

The DPF is effectively regenerated by a high temperature thereof while the engine is operated at a high RPM or in a high load condition, however the exhaust gas temperature needs to be forcibly raised so as to regenerate the DPF at a low RPM or in a low load condition.

Post-fuel injection is therefore performed, and a DOC (diesel oxidation catalyst) disposed at an upstream side of the DPF burns injected fuel to raise the temperature of the exhaust gas so as to regenerate the DPF. Conventionally, a sulfur component is included in diesel fuel, H2SO4 is formed in a combustion process and is attached on exhaust system components, and the attached H2SO4 absorbs moisture.

Meanwhile, while the diesel particulate filter is being regenerated, there is a problem that the moisture of the sulfuric acid (H2SO4) is evaporated by the high temperature to generate white smoke.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an exhaust gas post-treatment method having advantages of preventing white smoke that is generated by evaporating moisture from sulfuric acid that is attached to exhaust system components while a diesel particulate filter is regenerated.

In an aspect of the present invention, an exhaust gas post-treatment method, may include a white smoke elimination step that maintains a temperature of exhaust gas at a first predetermined temperature for a first predetermined time so as to eliminate moisture from a sulfur component, and a diesel particulate filter regeneration step that maintains a temperature of exhaust gas at a second predetermined temperature higher than the first predetermined temperature for a second predetermined time after the white smoke elimination step ends so as to burn particulate matter trapped in a diesel particulate filter.

The white smoke elimination step is performed one or more times for the first predetermined time respectively at predetermined time intervals, a middle rising step that raises a temperature of exhaust gas to a third predetermined temperature between the first predetermined temperature and the second predetermined temperature is performed after a final white smoke elimination step ends, and the diesel particulate filter regeneration step is performed after the middle rising step ends.

The first predetermined temperature ranges from 300 to 500 degrees Celsius, the first predetermined time is within 15 minutes, the second predetermined temperature ranges from 600 to 650 degrees Celsius, and wherein the second predetermined time is set when the regeneration of the diesel particulate filter is completed, and the third predetermined temperature is a value at which the diesel particulate filter is not damaged while an engine enters into an idle condition.

The white smoke elimination step is performed once, a middle rising step that raises a temperature of exhaust gas to a third predetermined temperature between the first predetermined temperature and the second predetermined temperature is performed after the white smoke elimination step ends, and the diesel particulate filter regeneration step is performed after the middle rising step ends.

The first predetermined temperature ranges from 300 to 500 degrees Celsius, the first predetermined time is within 15 minutes, the second predetermined temperature ranges from 600 to 650 degrees Celsius, and wherein the second predetermined time is set when the regeneration of the diesel particulate filter is completed, and the third predetermined temperature is a value at which the diesel particulate filter is not damaged while an engine enters into an idle condition.

The first predetermined temperature is repeatedly increased and decreased for a predetermined time by a predetermined cycle within the first predetermined time, wherein the first predetermined temperature ranges from 300 to 500 degrees Celsius, the first predetermined time is within 15 minutes, and the second predetermined temperature ranges from 600 to 650 degrees Celsius.

A middle rising step that raises a temperature of exhaust gas to the second predetermined temperature is performed two or more times for a third predetermined time with a predetermined time gap after the white smoke elimination step ends, and the diesel particulate filter regeneration step is performed after a final middle rising step ends for the second predetermined time, wherein the first predetermined temperature ranges from 300 to 350 degrees Celsius, the second predetermined temperature ranges from 600 to 650 degrees Celsius, and wherein the third predetermined time is less than 30 seconds and the second predetermined time is longer than 10 minutes.

In another aspect of the present invention, an exhaust gas post-treatment method, may include a white smoke elimination step that maintains a temperature of exhaust gas at a first predetermined temperature for a first predetermined time so as to eliminate moisture from a sulfur component, a middle rising step that raises a temperature of exhaust gas to a third predetermined temperature between the first predetermined temperature and a second predetermined temperature after the white smoke elimination step ends, and a diesel particulate filter regeneration step that maintains a temperature of exhaust gas at the second predetermined temperature that is higher than the first predetermined temperature for a second predetermined time after the middle rising step so as to burn particulate matter trapped in a diesel particulate filter, wherein the middle rising step is performed two or more times with a predetermined time gap, wherein the first predetermined temperature ranges from 300 to 500 degrees Celsius, the second predetermined temperature ranges from 600 to 650 degrees Celsius, the third predetermined time is within 5 minutes, and the second predetermined time is longer than 10 minutes.

As stated above, the moisture is slowly eliminated from the sulfur compound before the diesel particulate filter is regenerated, and therefore the white smoke that is caused by the evaporation of the moisture is prevented in the exhaust gas beforehand in the exhaust gas post-treatment method according to the present invention.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exhaust gas post-treatment method according to an exemplary embodiment of the present invention.

FIG. 2 is a graph showing a control method of an exhaust gas post-treatment method according to various exemplary embodiments of the present invention.

FIG. 3 is a graph showing a control method of an exhaust gas post-treatment method according to various exemplary embodiments of the present invention.

FIG. 4 is a graph showing a control method of an exhaust gas post-treatment method according to various exemplary embodiments of the present invention.

FIG. 5 is a graph showing a control method of an exhaust gas post-treatment method according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

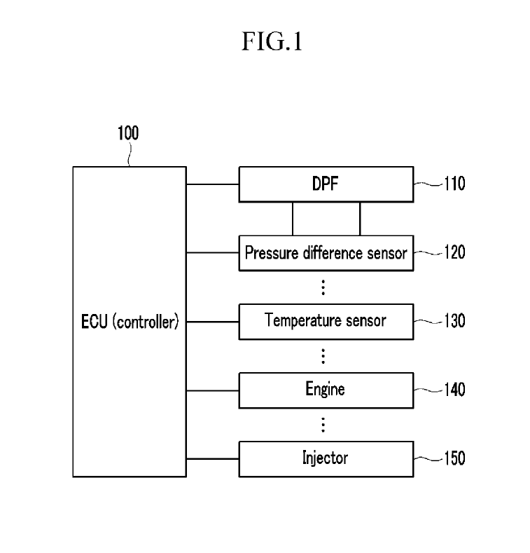

FIG. 1 is a schematic diagram of an exhaust gas post-treatment method according to an exemplary embodiment of the present invention.

Referring to FIG. 1, an exhaust gas post-treatment system includes a diesel particulate filter (DPF) 110, a pressure difference sensor 120, a temperature sensor 130, an engine 140, and an injector 150.

The diesel particulate filter 110 filters particulate matter included in exhaust gas, and the pressure difference sensor 120 detects a pressure difference between a front side and a rear side of the diesel particulate filter 110 and transmits the detected signal to a control portion 100.

The control portion 100 determines whether the diesel particulate filter 110 is to be regenerated or not according to the transmitted signal from the pressure difference sensor 120.

The control portion 100 can regenerate the diesel particulate filter 110 according to a predetermined travel distance or travel time regardless of the pressure difference sensor 120.

The exhaust gas that is to flow through the diesel particulate filter 110 is heated so as to regenerate the diesel particulate filter 110. In this process, the control portion 100 injects fuel through the injector 150 so as to raise the temperature of the exhaust gas that is transferred to the diesel particulate filter 110.

The injector 150 can be a fuel injection injector that is disposed in the engine 140 or a post-injection injector that is disposed on an exhaust line of an upstream side of the diesel particulate filter 110.

Further, the control portion 100 detects the temperature of the exhaust gas that is transferred to the diesel particulate filter 110 through the temperature sensor 130 and controls the injector 150 based on the detected temperature such that the temperature of the exhaust gas transferred to the diesel particulate filter 110 is included in a predetermined temperature range.

Accordingly, the PM (particular matter) that is trapped in the diesel particulate filter 110 is burned to be eliminated by the high temperature.

Meanwhile, a white smoke elimination mode is performed before the diesel particulate filter 110 is substantially regenerated so as to resolve the problem that the moisture included in the sulfur compound is evaporated and forms white smoke while the diesel particulate filter 110 is being regenerated in an exemplary embodiment of the present invention.

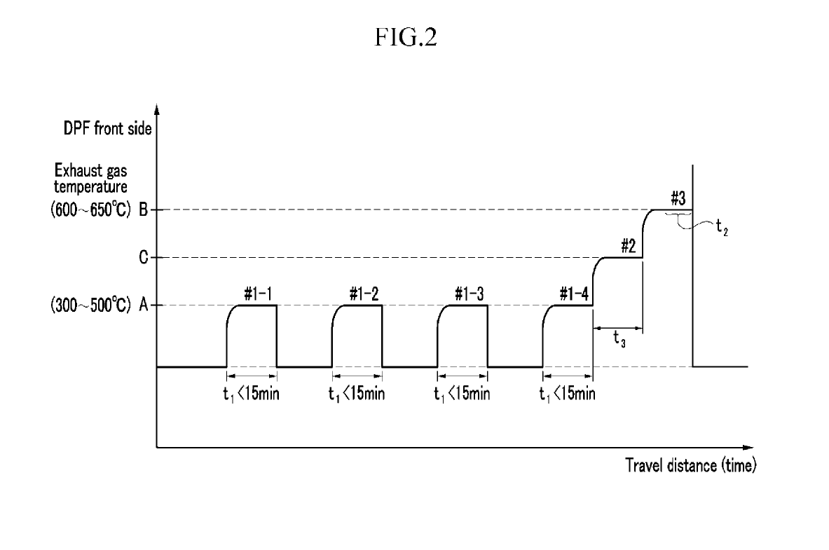

Hereinafter, a white smoke elimination mode will be detailed with reference to FIG. 2 to FIG. 4.

FIG. 2 is a graph showing a control method of an exhaust gas post-treatment method according to a first exemplary embodiment of the present invention.

Referring to FIG. 2, the horizontal axis denotes a travel distance or a travel time, and the vertical axis denotes temperature.

A first predetermined temperature (A) ranges from 300 to 500 degrees Celsius, a second predetermined temperature (B) ranges from 600 to 650 degrees Celsius, and a third predetermined temperature (C) is included between the first predetermined temperature (A) and the second predetermined temperature (B).

If it is determined that the diesel particulate filter 110 is to be regenerated, the control portion 100 controls the injector 150 to raise the temperature of the exhaust gas that is transferred to the diesel particulate filter 110.

As shown in FIG. 2, a white smoke elimination step #1 is performed, wherein the exhaust gas temperature is raised to maintain the first predetermined temperature (A) for the first predetermined time t1.

Here, the first predetermined time t1 is within 15 minutes. The white smoke elimination step #1 is performed four times (#1-1, #1-2, #1-3, #1-4) at predetermined intervals, and can be performed one or more times according to a driving condition and a sulfur content (travel distance).

Here, the moisture is slowly eliminated from the sulfur compound attached to the exhaust component.

The white smoke elimination step #1 is performed four times (this can be performed one or more times according to a driving condition or sulfur content), and then a middle rising step #2 in which the exhaust gas temperature is increased to a third predetermined temperature (C) is performed.

Here, when the engine 140 enters into an idle condition, the diesel particulate filter 110 is not damaged in the third predetermined temperature (C), and the third predetermined temperature (C) continues for the third predetermined time t3.

As soon as the middle rising step #2 ends, a diesel particulate filter regeneration step #3 in which the exhaust gas temperature is raised to the second predetermined temperature (B) is performed.

The PM trapped in the diesel particulate filter 110 is burned to be eliminated at the second predetermined temperature (B) during the diesel particulate filter regeneration step #3, and the diesel particulate filter regeneration step #3 is continued for the second predetermined time t2 until a predetermined amount of the PM is eliminated.

If the white smoke elimination step #1 and the middle rising step #2 are not performed and the diesel particulate filter regeneration step #3 is performed, the moisture is quickly evaporated from the sulfur compound of the exhaust component to generate the exhaust gas having a white color.

Accordingly, before the diesel particulate filter regeneration step #3 is performed, the white smoke elimination step #1 is performed more than one times to gradually evaporate sulfur compound such that it is prevented that the white smoke is generated during the diesel particulate filter regeneration step #3 in an exemplary embodiment of the present invention.

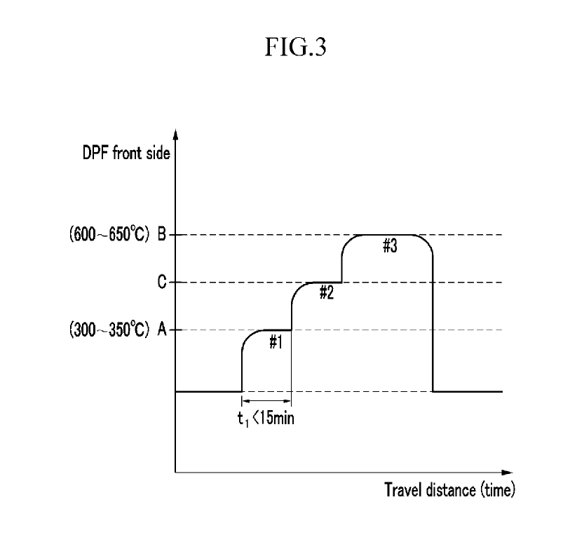

FIG. 3 is a graph showing a control method of an exhaust gas post-treatment method according to a second exemplary embodiment of the present invention.

Referring to FIG. 3, the white smoke elimination step #1 is performed at the first predetermined temperature (A) for the first predetermined time t1, wherein the first predetermined temperature (A) ranges from 300 to 500 degrees Celsius and the first predetermined time t1 is within 15 minutes.

As soon as the white smoke elimination step #1 ends, the exhaust gas temperature is raised to the third predetermined temperature (C) to perform the middle rising step #2.

Here, the third predetermined temperature (C) is a value at which the diesel particulate filter 110 is not damaged by the high temperature while the engine 140 enters into an idle condition, and the third predetermined temperature (C) is continued for the third predetermined time t3.

As soon as the middle rising step #2 ends, the temperature of the exhaust gas is raised to the second predetermined temperature (B) for the diesel particulate filter regeneration step #3.

The trapped PM of the diesel particulate filter 110 is combusted in the second predetermined temperature (B), and the diesel particulate filter regeneration step #3 is continued for the second predetermined time t2 until a predetermined amount of the trapped PM is eliminated in the diesel particulate filter regeneration step #3.

Accordingly, before the diesel particulate filter regeneration step #3 is performed, the white smoke elimination step #1 is performed to slowly evaporate the moisture from the sulfur compound of the exhaust line in an exemplary embodiment of the present invention, and therefore while the diesel particulate filter regeneration step #3 is being performed, the white smoke that is caused by the moisture of the sulfur compound is not formed.

Further, the middle rising step #2 prevents a sharp temperature fluctuation while the white smoke elimination step #1 is transformed to the diesel particulate filter regeneration step #3, and therefore the durability of the diesel particulate filter 110 is improved.

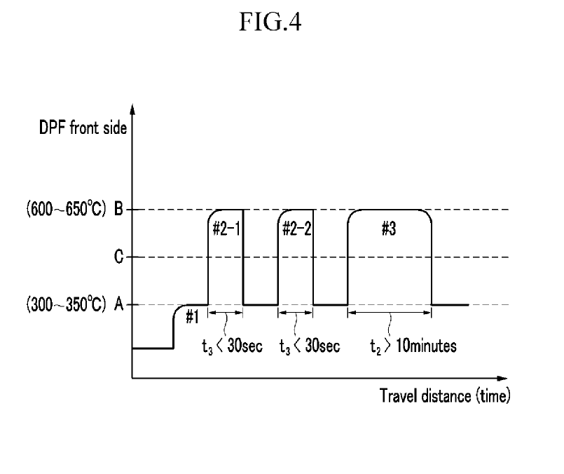

FIG. 4 is a graph showing a control method of an exhaust gas post-treatment method according to a third exemplary embodiment of the present invention.

The white smoke elimination step #1 is performed at the first predetermined temperature (A) for the first predetermined time t1, and the first predetermined temperature (A) ranges from 300 to 500 degrees Celsius.

As soon as the white smoke elimination step #1 ends, the exhaust gas temperature is increased to the second predetermined temperature (B) and the temperature (B) is maintained for the third predetermined time t3 in the middle rising step (#2).

Here, the second predetermined temperature (B) is a value at which a part of the PM trapped in the diesel particulate filter 110 is combusted, wherein the third predetermined time t3 is within 5 minutes.

The middle rising step #2 is performed for a relatively short time and is repeated two times #2-1 and #2-2 at predetermined intervals in an exemplary embodiment of the present invention.

However, the step #2 can be performed one or more times according to the driving condition and sulfur content (travel distance). When the middle rising step #2 ends and a predetermined time passes, the exhaust gas temperature is raised to the second predetermined temperature (B) in the diesel particulate filter regeneration step #3.

The second predetermined temperature (B) is a value at which a part of the PM trapped in the diesel particulate filter 110 is combusted to be eliminated, and the diesel particulate filter regeneration step #3 is continued until the predetermined amount of the PM is eliminated for the second predetermined time t2 in the diesel particulate filter regeneration step #3. Here, the second predetermined time t2 is continued for over 10 minutes such that the PM of the diesel particulate filter 110 is sufficiently burned to be eliminated.

The first predetermined time t1, the second predetermined time t2, and the third predetermined time t3 can be substantially predetermined, and can be times necessary for performing the white smoke elimination step #1, the middle rising step #2, and the diesel particulate filter regeneration step #3 in an exemplary embodiment of the present invention.

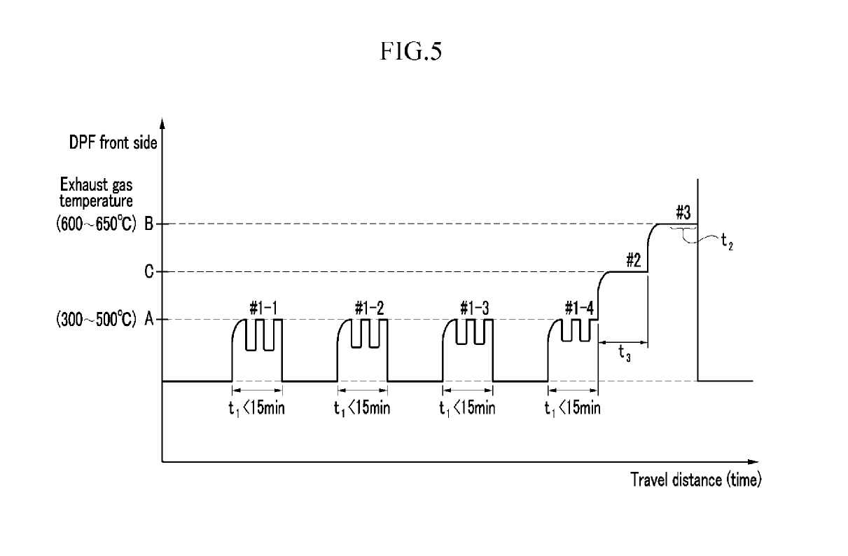

FIG. 5 is a graph showing a control method of an exhaust gas post-treatment method according to a fourth exemplary embodiment of the present invention. Referring to FIG. 5, the horizontal axis denotes a travel distance and the vertical axis denotes a temperature.

The first predetermined temperature (A) ranges from 300 to 500 degrees Celsius, the second predetermined temperature (B) ranges from 600 to 650 degrees Celsius, and the third predetermined temperature (C) is included between the first predetermined temperature (A) and the second predetermined temperature (B).

As shown, the exhaust gas temperature is raised to the first predetermined temperature (A) and the temperature (A) is maintained for the first predetermined time t1 during the white smoke elimination step #1. Here, the first predetermined time t1 is within 15 minutes. Here, the first predetermined temperature (A) can fluctuate or be repeatedly increased and decreased around the first predetermined temperature (A) for the first predetermined time t1.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas post-treatment method, comprising:
a white smoke elimination step that maintains a temperature of exhaust gas at a first predetermined temperature for a first predetermined time so as to eliminate moisture from a sulfur component; and
a diesel particulate filter regeneration step that maintains a temperature of exhaust gas at a second predetermined temperature higher than the first predetermined temperature for a second predetermined time after the white smoke elimination step ends so as to burn particulate matter trapped in a diesel particulate filter.

2. The exhaust gas post-treatment method of claim 1, wherein the white smoke elimination step is performed one or more times for the first predetermined time respectively at predetermined time intervals, a middle rising step that raises a temperature of exhaust gas to a third predetermined temperature between the first predetermined temperature and the second predetermined temperature is performed after a final white smoke elimination step ends, and the diesel particulate filter regeneration step is performed after the middle rising step ends.

3. The exhaust gas post-treatment method of claim 2, wherein the first predetermined temperature ranges from 300 to 500 degrees Celsius, the first predetermined time is within 15 minutes, the second predetermined temperature ranges from 600 to 650 degrees Celsius, and wherein the second predetermined time is set when the regeneration of the diesel particulate filter is completed, and the third predetermined temperature is a value at which the diesel particulate filter is not damaged while an engine enters into an idle condition.

4. The exhaust gas post-treatment method of claim 1, wherein the white smoke elimination step is performed once, a middle rising step that raises a temperature of exhaust gas to a third predetermined temperature between the first predetermined temperature and the second predetermined temperature is performed after the white smoke elimination step ends, and the diesel particulate filter regeneration step is performed after the middle rising step ends.

5. The exhaust gas post-treatment method of claim 4, wherein the first predetermined temperature ranges from 300 to 500 degrees Celsius, the first predetermined time is within 15 minutes, the second predetermined temperature ranges from 600 to 650 degrees Celsius, and wherein the second predetermined time is set when the regeneration of the diesel particulate filter is completed, and the third predetermined temperature is a value at which the diesel particulate filter is not damaged while an engine enters into an idle condition.

6. The exhaust gas post-treatment method of claim 2, wherein the first predetermined temperature is repeatedly increased and decreased for a predetermined time by a predetermined cycle within the first predetermined time.

7. The exhaust gas post-treatment method of claim 6, wherein the first predetermined temperature ranges from 300 to 500 degrees Celsius, the first predetermined time is within 15 minutes, and the second predetermined temperature ranges from 600 to 650 degrees Celsius.

8. The exhaust gas post-treatment method of claim 1, wherein a middle rising step that raises a temperature of exhaust gas to the second predetermined temperature is performed two or more times for a third predetermined time with a predetermined time gap after the white smoke elimination step ends, and the diesel particulate filter regeneration step is performed after a final middle rising step ends for the second predetermined time.

9. The exhaust gas post-treatment method of claim 8, wherein the first predetermined temperature ranges from 300 to 350 degrees Celsius, the second predetermined temperature ranges from 600 to 650 degrees Celsius, and wherein the third predetermined time is less than 30 seconds and the second predetermined time is longer than 10 minutes.

10. An exhaust gas post-treatment method, comprising:
a white smoke elimination step that maintains a temperature of exhaust gas at a first predetermined temperature for a first predetermined time so as to eliminate moisture from a sulfur component;
a middle rising step that raises a temperature of exhaust gas to a third predetermined temperature between the first predetermined temperature and a second predetermined temperature after the white smoke elimination step ends; and
a diesel particulate filter regeneration step that maintains a temperature of exhaust gas at the second predetermined temperature that is higher than the first predetermined temperature for a second predetermined time after the middle rising step so as to burn particulate matter trapped in a diesel particulate filter.

11. The exhaust gas post-treatment method of claim 10, wherein the middle rising step is performed two or more times with a predetermined time gap.

12. The exhaust gas post-treatment method of claim 10, wherein the first predetermined temperature ranges from 300 to 500 degrees Celsius, the second predetermined temperature ranges from 600 to 650 degrees Celsius, the third predetermined time is within 5 minutes, and the second predetermined time is longer than 10 minutes.
